(19) United States
(12) Patent Application Publication
(10) Pub. No.: US 2026/0316715 A1
(43) Pub. Date: Oct. 15, 2026

(54) METHOD AND DEVICE FOR UNLOCKING AN OPENING ELEMENT

(71) Applicant: Aumovio Germany GmbH, Frankful am Main (DE)

(72) Inventor: Steve LECOCQ, Le Chesnay-Rocquencourt (FR)

(73) Assignee: Aumovio Germany GmbH, Frankfurt am Main (DE)

(21) Appl. No.: 19/637,246

(22) Filed: Apr. 2, 2026

(30) Foreign Application Priority Data
Apr. 9, 2025 (FR) FR2503769

(51) Int. Cl. B60R 25/01; G06V 40/16; G06V 40/20

(52) U.S. Cl. CPC B60R 25/01; G06V 40/172; G06V 40/28

(57) ABSTRACT

A method for unlocking an opening element, including the following steps: observing a user authorized to open the opening element and approaching the opening element by a video image sensor; detecting the skeleton of a forearm of the user and their movements, by analyzing the video images; evaluating a first condition: a front arm approaches in the direction of position of the handle of the opening element; evaluating a second condition: the hand is at a distance from position of the handle of the opening element less than a given distance threshold; evaluating a third condition: biometric verification of the user. If all the evaluated conditions are satisfied, then the opening element is unlocked.

### FIELD OF THE INVENTION

### CROSS-REFERENCE TO RELATED APPLICATIONS

This application claims priority to FR2503769, filed Apr. 9, 2025, the contents of such application being incorporated by reference herein.

The invention relates to a method and a device for unlocking an opening element The invention is applicable to any opening element whose unlocking one wishes to restrict to at least one privileged user. More specifically, the invention is applicable to a motor vehicle whose access one wishes to restrict to its owner and/or persons authorized by the latter. In this context, an opening element is a door, left or right, front or rear of the vehicle, the tailgate window, the trunk lid, the engine compartment hood, or even the charging port flap or the fuel filler flap.

### BACKGROUND OF THE INVENTION

It is known that, to control the unlocking of an opening element, one uses a badge, possibly integrated into a smartphone, paired with the opening element or the system comprising the opening element, such as a motor vehicle. The system detects, without contact, the presence of said badge nearby to control the unlocking of the opening element. Such an approach has at least two drawbacks: the first is that badge detection does not verify that the badge holder is actually an authorized person, the second is that the system has no way of detecting a real intention to open the door. If someone comes into possession of the badge fraudulently, the system will allow them to open the door. Similarly, the mere proximity of the badge controls an unlocking, even though the user only approaches or remains near the opening element. This causes the system to unlock the opening element as soon as it detects a badge, and then to re-lock if there is no opening after a certain time. This can create a security breach and at the very least an unnecessary consumption of energy.

It is also known, in order to detect an intention to unlock, to place a sensor that detects a hand on or in the handle of the opening element. This approach has at least two drawbacks. A first drawback is that the detection of a hand generally does not verify that the hand belongs to an authorized person. A second drawback is that this approach requires the addition of a sensor. This additional cost limits its use to the main opening elements: driver and passenger doors in the case of a vehicle, excluding other opening elements: rear doors, trunks, flaps.

Therefore, a method and a device for unlocking an opening element are sought that correct these drawbacks by detecting a real intention to unlock and by authenticating its author.

### SUMMARY OF THE INVENTION

For this purpose, an aspect of the invention relates to a method for unlocking an opening element, comprising the following steps:
observing a user authorized to open the opening element (2) and approaching said opening element by means of a video image sensor,
detecting the skeleton of an arm of the user and its movements, by analysis of the video images,
evaluating a first condition: an arm approaches in the direction of the position of the handle of the opening element,
evaluating a second condition: the hand is at a distance from the position of the handle of the opening element less than a given distance threshold,
evaluating a third condition: biometric verification of the user,
if all the evaluated conditions are satisfied, then the opening element is unlocked.

Specific features or embodiments, usable alone or in combination, are:
detecting an arm skeleton and its movements is performed by a posture analysis algorithm,
the first condition is satisfied if an arm skeleton segment, with the hand forward, is directed towards the handle position,
the distance threshold of the second condition is equal to 50 cm, preferably 30 cm,
the biometric verification is facial recognition or gait recognition or, less preferably, voice recognition or fingerprint recognition or iris scan recognition or at least two of the preceding recognition methods,
the method also includes an evaluation of a fourth condition: identity theft prevention,
identity theft prevention is performed according to Level B of the FIDO (for “Fast Identification Online”) standard or according to Level 2 of the ISO 30107 standard,
the method also includes an evaluation of a fifth condition: detection of an authorized badge nearby, preferably associated with the user biometrically verified by the third condition.

According to another aspect, the invention covers a device for unlocking an opening element, including a processing unit, at least one video image sensor connected to the processing unit and at least one opening element unlocking actuator connected to the processing unit, the processing unit being capable of implementing a method as described in this document, to control the unlocking actuator in order to unlock the opening element.

### BRIEF DESCRIPTION OF THE DRAWINGS

An aspect of the invention will be better understood upon reading the following description, given solely by way of example, and with reference to the figures in the appendix in which:

FIG. 1 shows, in schematic view, an arm and a hand of a user approaching the position of the handle of an opening element,

FIG. 2 shows, in schematic view, the conditions for validating the first condition,

FIG. 3 shows, in schematic view, the composition of a device according to an aspect of the invention.

### DESCRIPTION OF THE EMBODIMENTS

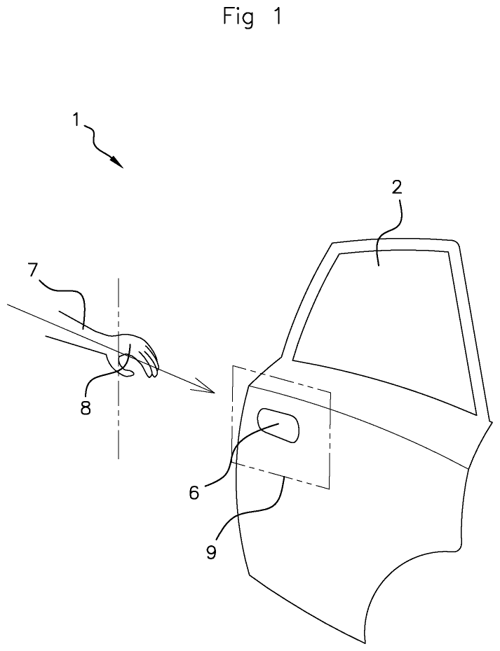

With reference to FIG. 1, an aspect of the invention relates to a method for unlocking an opening element 2. This method includes the following steps. In a first step, a user approaching the opening element 2 of a vehicle is observed by means of a video image sensor 4 integrated into said vehicle (see FIG. 3). From the video images thus captured by sensor 4, an image analysis is carried out in order to detect the user's skeleton and the movements of this skeleton. More specifically, the analysis focuses on the user's posture and even more on detecting the position of the skeleton of the user's forearm 7 and hand 8. This analysis detects the position of said forearm 7 and its movement.

A first condition is evaluated based on this detection. Is a forearm 7 approaching position 9 of handle 6 of the opening element 2? This first condition is considered to indicate an intention to unlock on the part of the user.

From this detection, a second condition is evaluated, indicative of proximity. It is verified that hand 8, detected in the previous step by the skeleton detection algorithm, is located at a distance from position 9 of handle 6 of the opening 2 that is less than a given distance threshold. If that is the case, the condition is deemed satisfied.

In order to ensure that forearm 7 which approaches handle 6 of an opening element 2 is indeed that of an authorized person, a third condition is evaluated: the user is subjected to a biometric verification.

Other conditions can be added to this method, as will be seen later. If all (intersection or logical AND) evaluated conditions are satisfied, the method controls an unlocking of opening element 2.

The video image sensor 4 can be of any type. This can be a single camera equipped with a wide-angle lens or a conical mirror to provide a panoramic view around the opening element 2 or the system including at least one opening element 2, such as a vehicle.

In the context of driver assistance or autonomous driving, a vehicle is advantageously equipped with such a video image sensor 4. This can therefore involve several, typically four, video cameras, positioned around the vehicle to provide a panoramic view of the vehicle's surroundings.

Thus, in the context of a panoramic sensor 4 or a plurality of sensors forming an existing panoramic sensor 4, the latter is advantageously reused. Therefore, in such a case, an aspect of the invention does not require a specific sensor.

According to another feature, the detection of the skeleton and its movements is assumed to be known. For example, it is performed by a POSE-type posture analysis algorithm (POSE being the English term for position and posture). Such an algorithm includes several implementations: Yolo, MediaPipe Pose, OpenPose, etc. For illustrative purposes, you can consult the following website: https://viso.ai/deep-learning/pose-estimation-ultimate-overview/.

As seen previously, a known algorithm makes it possible to identify the skeleton of a user approaching opening element 2. A user is considered to be approaching opening element 2 when they enter the field of sensor 4.

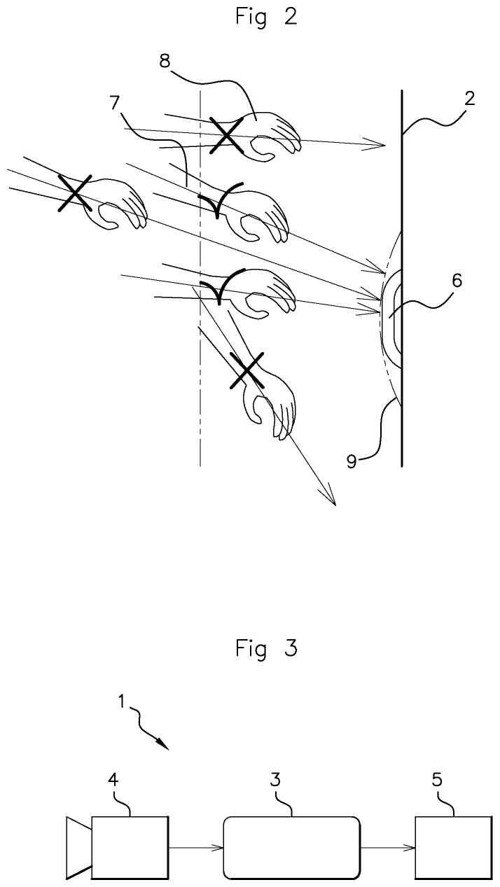

According to another feature, more specifically illustrated in FIG. 2, the first condition is satisfied if a skeleton segment of the forearm 7 is directed towards position 9 of handle 6. It is further advantageously verified that hand 8 in front of said forearm 7 is also directed towards handle 6. To this end, as illustrated in FIG. 2, it is verified that forearm 7, when extended, points in the area of position 9 around the handle 6. Thus, as illustrated in FIG. 2, some configurations of forearm 7 are valid and others are not, because they do not clearly demonstrate an intention on the part of the user to bring their hand 8 closer to handle 6.

The concept of position 9 of the handle 6 is used in the present description for at least two reasons. A first reason is that position 9 is an augmented area around the effective handle 6, in order to create an increased tolerance for validating the first condition.

A second reason is that the handle 6 is virtual. Indeed, thanks to an aspect of the invention, it is possible to remove handle 6 from an opening element 2 as an opening member. Position 9 is an area, not necessarily materialized, but known to the user, towards which they extend their hand to indicate their intention to open the opening element 2.

According to an embodiment without handle 6, the invention allows the opening element 2 to be unlocked so that it opens ajar. The user then passes their hand behind the wall of opening element 2. Grasping this wall then acts as a handle to open opening element 2. It can be noted that the absence of a handle 6 is already effective in the case of an engine compartment, a charging port flap or the fuel filler flap.

According to another feature, the distance threshold of the second condition is chosen such that it indicates a real proximity of hand 8 and confirms a real intention to unlock. The threshold is a compromise. A high threshold advantageously allows for earlier detection and thus provides time for subsequent processing, guaranteeing a good response time of the device 1. Conversely, a high threshold tends, detrimentally, to increase the number of false detections. By way of indication, this threshold is set to be equal to 50 cm. Preferably, it is set to be equal to 30 cm.

The first two conditions detect an intention to unlock by a user. However, it is necessary to verify that this user is authorized to request unlocking. Thus, according to another feature, at least one biometric verification is carried out.

This verification is preferably facial recognition or gait recognition. Indeed, these two verifications can advantageously be carried out using the same video image sensor 4. In this case, the verification is carried out during the approach of the user, advantageously in parallel with, or even prior to, skeleton detection.

Alternatively or in addition, it is also possible for biometric verification to proceed with voice recognition, fingerprint recognition, iris scan recognition. These recognition methods are less preferred in that they require the addition of at least one additional sensor: microphone for voice, contact sensor for fingerprint or ocular imaging sensor for iris scan.

According to another feature, particularly to increase the security of recognition, double (or multiple) authentication can be performed. To achieve this, at least two of the previous recognition steps are carried out.

According to another feature, the security of the authentication method is further strengthened by the addition of a fourth condition of identity theft prevention.

This condition aims to prevent attempts at identity theft, such as presenting a photo of an authorized person or using a mask, instead of a face, to deceive facial recognition, etc.

Such a condition of identity theft prevention is, in an indicative manner, carried out according to level B of the FIDO (“Fast Identification Online) standard or according to level 2 of the ISO 30107 standard.

According to another feature, the method may include an evaluation of a fifth condition. This condition consists of detecting an authorized badge nearby. This badge is preferably personally associated with the user biometrically verified by the third condition. The combination of these two conditions offers enhanced security.

The method, as described, is advantageously applicable to all opening elements 2 of a vehicle. Indeed, the image and movement analysis of the skeleton is capable of detecting an approach of a forearm 7 towards any of the opening elements 2 by identifying each opening element 2. The ordered unlocking is then advantageously limited to only the opening element 2 in question.

Conversely, similarly to centralized unlocking, the unlocking can be extended to all the opening elements 2, upon detection of an intention to unlock an opening element.

An aspect of the invention further relates to a device 1 for unlocking an opening element 2. This device 1, more particularly illustrated in FIG. 3, includes a processing unit 3, at least one video image sensor 4 connected to processing unit 3 and at least one unlocking actuator 5 for an opening element 2 connected to processing unit 3. The video image sensor 4 is capable of capturing video images of a user approaching the device 1. The processing unit 3 is capable of performing the various processing operations and in particular the analysis of the video images and the analysis of the movements of the skeleton.

According to one feature, processing unit 3 is capable of implementing the method described above, to control the unlocking actuator 5 in order to unlock opening element 2.

The invention has been illustrated and described in detail in the drawings and the preceding description. The latter should be considered illustrative and given as an example, and should not be taken as limiting the invention to this description alone. Numerous design variations are possible.

1. A method for unlocking an opening element, the method comprising:
observing a user authorized to open the opening element and approaching said opening element by a video image sensor,
detecting the skeleton of a forearm of the user and its movements, by analyzing video images,
evaluating a first condition: a forearm approaches in the direction of the position of the handle of the opening element,
evaluating a second condition: the hand is at a distance from the position of the handle of the opening element that is less than a given distance threshold,
evaluating a third condition: biometric verification of the user,
if all the evaluated conditions are satisfied, then the opening element is unlocked.

2. The method according to claim 1, wherein the detection of the skeleton of a forearm and its movements is carried out by a posture analysis algorithm.

3. The method according to claim 1, wherein the first condition is satisfied if a forearm skeleton segment, with the hand forward, is directed toward the position of the handle.

4. The method according to claim 1, wherein the distance threshold of the second condition is equal to 50 cm, preferably 30 cm.

5. The method according to claim 1, wherein the biometric verification is facial recognition or gait recognition or, less preferably, voice recognition or fingerprint recognition or iris scan recognition or at least two of the preceding recognition methods.

6. The method according to claim 1, further comprising an evaluation of a fourth condition: identity theft prevention.

7. The method according to claim 1, further comprising an evaluation of a fifth condition: detection of an authorized badge nearby, preferably associated with the user biometric ally verified by the third condition.

8. A device for unlocking an opening element, including a processing unit, at least one video image sensor connected to the processing unit and at least one unlocking actuator for an opening element connected to the processing unit, characterized in that wherein the processing unit is capable of implementing the method according to claim 1, to control the unlocking actuator in order to unlock the opening element.
